(19) United States
(12) Patent Application Publication
(10) Pub. No.: US 2009/0323812 A1
(43) Pub. Date: Dec. 31, 2009

(54) PROCESS FOR DELIVERING A VIDEO STREAM OVER A WIRELESS CHANNEL

(75) Inventors: Yann Leprovost, Nozay (FR); Cedric Marin, Nozay (FR)

Correspondence Address: FAY SHARPE/LUCENT, 1228 Euclid Avenue, 5th Floor, The Halle Building, Cleveland, OH, 44115-1843, US

(73) Assignee: Alcatel-Lucent, Paris (FR)

(21) Appl. No.: 12/332,062

(22) Filed: Dec. 10, 2008

(30) Foreign Application Priority Data
Dec. 11, 2007 (EP) 07291489.8

(51) Int. Cl. H04N 7/26; H04N 7/24

(52) U.S. Cl. 375/240.16; 375/E07.021; 375/E07.125

(57) ABSTRACT

Process for delivering a video stream over a wireless channel, wherein the video frames of the video stream are encoded by defining partitions of the video frames, said encoding being done by determining predictions for the partitions, a prediction being based on two reference areas (A1, A2) each of independent reference frames of the video stream; one motion vector associated to each reference area (A1, A2); and a weighting factor (W1, W2) for each motion vector; wherein the difference between partition and corresponding predicted partition is done in order to establish a partition residual, the encoded video stream with partition residuals are transmitted to a video decoder in order to decode predicted partition of the video stream by using the two reference areas (A1, A2), the motion vectors and weighting factor based on encoded weighting factor (W1, W2) balanced by a transmission error probability (P_{A1}, P_{A2}) computed for each reference area (A₁, A₂), decoded partition (M) of the video frame being formed by combination of decoded predicted partition and corresponding partition residual.

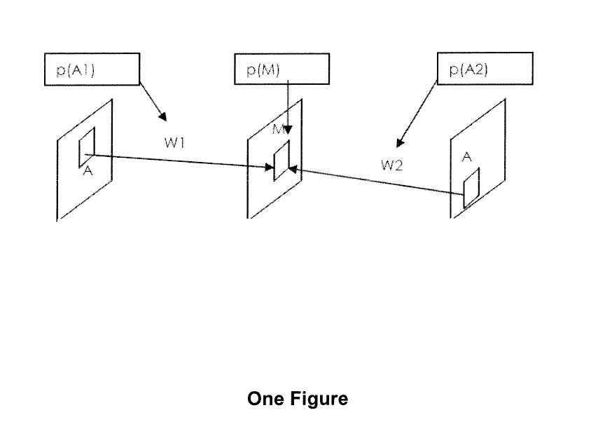

The invention relates to a process for delivering a video stream over a wireless channel, a video decoder and a radio decoder for implementing said process.

Video stream transmission over a wireless channel consists in encoding a video stream, composed of many video frames, by a video encoder in order to be transmitted to a radio encoder. The video stream is then transmitted as a radio signal over a wireless channel to a radio decoder. The radio decoder changes the signal into bits to transmit it to a video decoder that rebuilds the original video stream.

In a known manner video stream transmission over a wireless channel commonly uses inter frame prediction, also known as motion compensation. This method is used in all already deployed video compression systems and also for recent standards such as H.264 standard.

Video compression consists in predicting a block of a video frame (also called a macroblock in H.264) by translating an area of at least one reference frame using a motion vector. Many types of macroblocks exist. For example, intra predicted macroblock, called I macroblock, is predicted upon spatial neighboring macroblocks of the current frame and P macroblock uses a single independent reference area.

The present invention applies to B macroblock as it is the most efficient method in terms of compression efficiency.

B macroblock uses a bipredictive motion compensation using two reference video areas and two motion vectors. The two predictions are processed independently, each one using its own reference area. The two predicted areas are summed using weight factors.

Each B macroblock can then be used for future prediction and artifact propagation and expansion is due to the fact that frames are predicted upon a previous decoded frame. As a P macroblock could propagate errors contained in a single reference frame, a B macroblock could propagate errors contained in the two reference frames.

A common scheme for handling video artifact propagation is the periodic insertion of I macroblocks, as erroneous macroblocks from previous reference frames are not used in the prediction scheme. Inter frame artifact propagation is then stopped.

This prediction method is not efficient in terms of compression. More often intra macroblocks are refreshed, higher is the protection against inter frame artifact propagation, but lower is compression efficiency as it requires lots of bandwidth.

In this decoding method according to prior art, information from the radio decoder is not used but most wireless transmission systems integrate decoding functions that reduces the bit error rate at input of the video decoder. At video decoder input, a binary stream (i.e. bits threshold) is used; video decoder does not use probabilistic information from the radio decoder (e.g. outputs such as log likelihood ratio associated to macroblocks coded sequence).

The purpose of the invention is to resolve the problems of the prior art by proposing, in particular, a process for delivering a video stream over a wireless channel using transmission error probability for decoding B macroblock in order to minimize artefact propagation.

For that purpose and according to a first aspect, the invention relates to a process for delivering a video stream over a wireless channel, wherein the video frames of the video stream are encoded by defining partitions of the video frames, said encoding being done by determining predictions for the partitions, a prediction being based on:
two reference areas each of independent reference frames of the video stream;
one motion vector associated to each reference area; and
a weighting factor for each motion vector;
   wherein the difference between partition and corresponding predicted partition is done in order to established a partition residual, the encoded video stream with partition residuals are transmitted to a video decoder in order to decode predicted partition M of the video stream by using the two reference areas, the motion vectors and weighting factor based on encoded weighting factor balanced by a transmission error probability computed for each reference area, decoded partition of the video frame being formed by combination of decoded predicted partition and corresponding partition residual.

According to a second aspect, the invention relates to video decoder for implementing the process, said video decoder comprising means to decode predicted partition M of the video stream by using the two reference areas, the motion vectors and weighting factor based on encoded weighting factor balanced by a transmission error probability computed for each reference area, and means to form decoded partition of the video frame by combination of decoded predicted partition and corresponding partition residual.

According to a third aspect, the invention relates to a radio decoder destined to be connected with a video decoder, said radio decoder comprising means to compute transmission error probability according to reliability criteria of the transmission of corresponding reference area.

Other aspects and advantages will become apparent in the following description made with reference to the appended FIGURE which represents a B macroblock motion compensation scheme.

The process for delivering a video stream over a wireless channel according to the invention proposes to encode video frames of the video stream by defining partitions of the video frames by a video encoder.

In the described embodiment, the video encoding is achieved according to H.264 standard, notably according to H.264 AVC one and each partition is a, a B macroblock's partition or subpartition as defined in the standard.

As B macroblock uses bipredictive motion compensation, the encoding is done by determining predictions for the partitions, a prediction being based on:
two reference areas A1, A2 each of independent reference frames of the video stream;
one motion vector associated to each reference area A1, A2; and
a weighting factor W1, W2 for each motion vector;

The weighting factor allows determining the contribution of each reference area in the predicted partition. In H.264 standard weighting factor default value is 0.5 for each area, but it can also be explicitly defined.

At this stage, the difference between partition and corresponding predicted partition is done in order to establish a partition residual.

The video encoder forwards the encoded video stream with partition residuals to a radio encoder that transmits it then as a radio signal over a wireless channel to a radio decoder.

The radio decoder comprises means to compute transmission error probability P_{A1}, P_{A2} according to reliability criteria of the transmission of corresponding reference area A1, A2. Such transmission error probability is for example pixels probability.

Reliability criteria can be determined from either:
log likelihood ratio from the radio decoder; or
bit error rate estimator; or
simple Cyclic Redundancy Check computation.

The transmission error probability P_{A1}, P_{A2} can also be computed upon visual metrics on decoded predicted partition.

The encoded video stream with partition residual are transmitted to a video decoder comprising means to decode predicted partition of the video stream by using the two reference areas A1, A2, the motion vectors and weighting factor based on weighting factors W1, W2 balanced by the transmission error probability P_{A1}, P_{A2} computed for each reference area A1, A2.

The weighting factor balanced this way allows taking into consideration how reliable the reference area A1, A2 is. It decreases the importance of a reference area with high error probability that probably contains artefact. Consequently, such prediction in the video decoder allows minimizing video artefacts as well as saving bandwidth.

The video decoder rebuilds then the decoded partition M of the video frame which is formed by combination of decoded predicted partition and corresponding partition residual.

According to the FIGURE, the biprediction algorithm of a decoded partition M is: M=A1*f(W1, P_{A1})+A2*f(W2, P_{A2}), where f(W1, P_{A1}) and f(W2, P_{A2}) are balanced weighting factors upon probabilities.

In a further embodiment, the decoded partition M can be used as reference area for encoding another partition, notably as provided in H.264 AVC.

To keep on minimizing video artefact during the video stream transmission, a transmission error probability associated to this new reference area is computed. The transmission error probability P_{M} of the decoded partition is computed with transmission error probabilities P_{A1} and P_{A2} balanced with corresponding weighting factor W1, W2, as well as transmission error probability of the partition residual.

Using information concerning previous reference areas A1, A2 and M, such as transmission error probabilities P_{A1}, P_{A2} and P_{M}, allows keeping a trace of reconstructed areas reliability, decreasing future error propagation, and thus, artefacts propagation.

1. Process for delivering a video stream over a wireless channel, wherein the video frames of the video stream are encoded by defining partitions of the video frames, said encoding being done by determining predictions for the partitions, a prediction being based on:
two reference areas (A1, A2) each of independent reference frames of the video stream;
one motion vector associated to each reference area (A1, A2); and
a weighting factor (W1, W2) for each motion vector;
wherein the difference between partition and corresponding predicted partition is done in order to establish a partition residual, the encoded video stream with partition residuals are transmitted to a video decoder in order to decode predicted partition of the video stream by using the two reference areas (A1, A2), the motion vectors and weighting factor based on encoded weighting factor (W1, W2) balanced by a transmission error probability (P_{A1}, P_{A2}) computed for each reference area (A₁, A₂), decoded partition (M) of the video frame being formed by combination of decoded predicted partition and corresponding partition residual.

2. Process according to claim 1, wherein the video encoding is achieved according to H.264 standard, notably according to H.264 AVC one.

3. Process according to claim 2, wherein each partition is a B macroblock as defined in the standard.

4. Process according to claim 1, wherein transmission error probability (P_{A1}, P_{A2}) is computed upon radio decoding of the transmission, said computing being done according to reliability criteria of the transmission of corresponding reference area (A1, A2).

5. Process according to claim 4, wherein reliability criteria is determined from either:
log likelihood ratio from the radio decoder; or
bit error rate estimator; or
simple Cyclic Redundancy Check computation.

6. Process according to claim 1, wherein transmission error probability (P_{A1}, P_{A2}) is computed upon visual metrics on decoded predicted partition.

7. Process according to claim 1, wherein a decoded partition (M) is used as reference area for encoding another partition, the transmission error probability (P_{M}) of the decoded partition (M) being computed with transmission error probabilities (P_{A1} and P_{A2}) balanced with corresponding weighting factor (W1, W2), as well as transmission error probability of the partition residual.

8. Video decoder for implementing the process according to any of previous claims, said video decoder comprising means to decode predicted partition of the video stream by using the two reference areas (A1, A2), the motion vectors and weighting factor based on encoded weighting factor (W1, W2) balanced by a transmission error probability (P_{A1}, P_{A2}) computed for each reference area (A₁, A₂), and means to form decoded partition (M) of the video frame by combination of decoded predicted partition and corresponding partition residual.

9. Video decoder according to claim 8, comprising means to compute transmission error probability upon visual metrics on decoded predicted partition.

10. Radio decoder destined to be connected with a video decoder according to claim 8, said radio decoder comprising means to compute transmission error probability (P_{A1}, P_{A2}) according to reliability criteria of the transmission of corresponding reference area (A1, A2).
